(19) United States
(12) Patent Application Publication
(10) Pub. No.: US 2014/0275759 A1
(43) Pub. Date: Sep. 18, 2014

(54) ORAL SEX STIMULATOR

(71) Applicants: Kin Wai Lee, Hong Kong (HK); Chun Yin Cheung, Belfast (GB)

(72) Inventors: Kin Wai Lee, Hong Kong (HK); Chun Yin Cheung, Belfast (GB)

(73) Assignee: Kin Wai Lee, Hong Kong (HK)

(21) Appl. No.: 13/843,983

(22) Filed: Mar. 15, 2013

(51) Int. Cl. A61H 23/00; A61H 19/00

(52) U.S. Cl. CPC A61H 23/00; A61H 19/30
USPC 600/38; 601/46

(57) ABSTRACT

An oral sex stimulator includes: a battery powered body including a battery compartment, a silicone cover and a one or more controls; and a tail attached to the body, wherein the tail includes a bend adjacent to the body, an elongated arm extending away from the bend, and a hooked end at the terminal end of the tail. In some embodiments, the body is a vibrating body. In others, the body includes a heating element.

### BACKGROUND OF THE INVENTION

The present subject matter relates generally to an oral sex stimulator. More specifically, the present subject matter discloses an oral sex stimulator that includes a vibrating body that fits into a user's mouth and a tail that enables the user to comfortably and securely hook the body inside the user's mouth.

There are numerous electro-mechanical sexual stimulators available on the market. The majority of these stimulators are not intended or adapted for use during oral sex, in fact, very few devices are adapted for such purposes. In one example, U.S. Pat. No. 6,645,164 (the '164 patent) discloses a vibrating oral sex enhancement device including a mouthpiece and a separate controller. The surface of the mouthpiece contacts the user's tongue to impart vibrations to the user's tongue, which is intended to provide increased sexual pleasure to the user's partner during oral sex. However, the device disclosed in the '164 patent is inconvenient, obtrusive, and does not provide direct stimulation—the stimulation is indirectly provided through the tongue. The device disclosed in the '164 patent is specifically intended for use in cunnilingus.

Other examples include a vibrator attached to an elastic ring wrapped around the users tongue. Securing such a device on an active and tapered tongue is a challenge. A more secure device, a vibrator that attaches to the user's tongue by a shaft secured though the tongue may be more secure, but is limited for use by people having pierced tongues.

The prior art does not provide a convenient oral sex stimulator that can be safely and securely held in a user's mouth while performing fellatio that enables a user to complete close his or her mouth and otherwise does not interfere with the natural movement of the user's mouth and tongue while providing direct stimulation to the penis.

Accordingly, there is a need for an oral sex stimulator, as described and claimed herein.

### BRIEF SUMMARY OF THE INVENTION

The present disclosure provides a convenient oral sex stimulator that can be safely and securely held in a user's mouth while performing fellatio that enables a user to complete close his or her mouth and otherwise does not interfere with the natural movement of the user's mouth and tongue while providing direct stimulation to the penis. A description of a representative example of an oral sex stimulator is provided below, but it is understood that the subject matter provided herein may be varied to accommodate particular applications, as will be recognized by those skilled in the art based on the teachings provided herein.

In one example, an oral sex stimulator includes a vibrating body and a tail for securing the body within the user's mouth. The body is a vibrating, elongated, egg-shaped structure. In a preferred embodiment, the body is covered in a medical grade silicone, both for comfort and for ease of cleaning. The silicone cover encloses a battery powered electromechanical vibration device and a battery. A power switch (and, in some embodiments, a vibration intensity control) is provided at the outer surface of the body to control the operation of the vibration device.

In another example, the shape of the oral sex stimulator may be generally the same as the first embodiment described above; however, in this example, the body is a heat producing body. Heat may be provided by a battery powered warming device, for example, a battery-powered electrical resistance heating element. Another contemplated embodiment may combine the functionality described above to provide a vibrating, heat producing body. Such an embodiment may include independent controls accessible at the outer surface of the body to turn on and off the heat and the vibration, as well as to control the intensity of each. As shown, the body may be adapted to perform varied functionality to improve the user's ability to stimulate another during oral sex.

The shape and size of the body is specifically adapted to comfortably fit into the user's cheek without interfering with the user's tongue and without impeding the user's ability to close his or her mouth. While described primarily as an elongated egg-shaped body, the body may take other forms. For example, it is contemplated that the body may include a convex cheek-facing surface and a concave tongue-facing surface that may more readily conform to the geometry of the cheek on one side and the penis on the other. Certainly other shapes may be employed, but the preferred versions embody smoothly contoured shapes that are most likely to be comfortable and safe for the user.

In a preferred embodiment, the tail portion of the oral sex stimulator includes a bend, an elongated curved arm, and a hooked end. The tail allows the oral sex stimulator to be safely and securely “clipped” onto the user's mouth to place the body within the user's mouth. This structure prevents the body (or the entire device) from being advanced too far into the user's mouth and choking the user. In this preferred embodiment, the tail is both thin and made from a transparent material, which makes the oral sex stimulator particularly unobtrusive. By providing a relatively thin tail, the user may maintain the ability to completely close his or her mouth even with the oral sex stimulator secured in place for use. By making the tail from a transparent, or other non-obtrusive, material, the oral sex stimulator may be less obvious and more attractive.

The curved shape of the tail comfortably holds the body in place within the user's mouth. And because the end of the tail is hooked, the user is able to slide the oral sex stimulator into his or her mouth smoothly, without a risk of scratching the face. Further, because the hooked end of the tail is positioned away from the user's mouth back towards the user's cheek, the hooked end is less likely to interfere with any interaction between the two people.

The tail may be formed from any of a number of suitable materials. In one example, the tail is formed from stainless steel which provides a very strong, stable, and easy to clean device. In other embodiments, the tail may be formed from any of a variety of suitable plastics. Such versions may be both easy to clean and lightweight. Polymeric versions of the tail may be able to take advantage of transparency to minimize the visual impact of the device.

As described, an oral sex stimulator includes: a battery powered body including a battery compartment, a silicone cover and a one or more controls; and a tail attached to the body, wherein the tail includes a bend adjacent to the body, an elongated arm extending away from the bend, and a hooked end at the terminal end of the tail. In some embodiments, the body is a vibrating body. In others, the body includes a heating element. The oral sex stimulator may include a power control, an intensity control, or similar controls. Variations of the oral sex stimulator include various shaped bodies, for example, an egg-shaped body or a body that includes a convex cheek-facing surface and a concave tongue-facing surface. In some versions the tail may be formed from a transparent polymer.

In another embodiment, the tail is configured to clip around a cheek of the user when the body is placed inside a user's mouth. Further, the hooked end may be configured to hook around a user's ear.

An advantage of the oral sex stimulator provided herein is that it may be safely and securely held in a user's mouth while performing fellatio that enables a user to complete close his or her mouth and otherwise does not interfere with the natural movement of the user's mouth and tongue while providing direct stimulation to the penis.

Another advantage of the oral sex stimulator provided herein is that it may be adapted to incorporate any number of functions, including, for example, vibration, heating, etc.

A further advantage of the oral sex stimulator provided herein is that it prevents the body from being inserted too deeply into the user's mouth.

Yet another advantage of the oral sex stimulator provided herein is that it provides an unobtrusive and attractive oral sex stimulator.

Another advantage of the oral sex stimulator provided herein is that the user is able to freely move his or her tongue during use.

Still another advantage of the oral sex stimulator provided herein is that the materials and shapes used enable comfortable use and sanitary cleaning.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of an oral sex stimulator according to the present invention.

FIG. 2 is a cross-sectional view of the oral sex stimulator of FIG. 1.

FIG. 3 is a cross-sectional view of an alternate embodiment of the oral sex stimulator of FIG. 1.

FIG. 4 is a perspective view of another alternative embodiment of the oral sex stimulator of FIG. 1.

FIG. 5 is a perspective view of the insertion of the oral sex stimulator of FIG. 1 into a user's mouth.

FIG. 6 is a front view of the oral sex stimulator of FIG. 1 located in a user's mouth.

### DETAILED DESCRIPTION OF THE INVENTION

FIGS. 1-4 illustrate various views of examples of an oral sex stimulator 10, as provided herein. The example shown in FIGS. 1-2 is one example of an oral sex stimulator 10, the example shown in FIG. 3 is another example of an oral sex stimulator 10, FIG. 4 is yet another example of an oral sex stimulator 10, and those skilled in the art will recognize the numerous variations of embodiments that may be implemented based on the teachings disclosed herein. FIGS. 5 and 6 show how a user 12 may wear the oral sex stimulator 10.

In the example shown in FIGS. 1 and 2, the oral sex stimulator 10 includes a body 14 and a tail 16. The body 14 shown in FIGS. 1 and 2 is a vibrating, elongated, egg-shaped body 14. However, it is understood that the body 14 may take many forms. Of particular importance, the body 14 should be comfortable, safe, and secure when in use. To meet these goals, the body shown in FIGS. 1 and 2 is smoothly shaped and covered in a medical grade silicone. The silicone material improves user comfort and makes the oral sex stimulator 10 easy to clean. As shown in FIG. 2, a silicone cover 18 encloses a battery powered electromechanical vibration device 20 and a battery compartment 22 into which an appropriate battery may be placed. A power switch 24 (and, in some embodiments, a vibration intensity control 26) is provided at the outer surface 28 of the body 14 to control the operation of the vibration device 20.

In the example shown in FIG. 3, the oral sex stimulator 10 may be generally the same as the embodiment shown in FIGS. 1 and 2; however, the body 14 may be a heat producing body 14, rather than a vibrating body 14. A battery powered warming device 30 may be used to provide the heat producing body 14. For example, the warming device 30 may be a battery-powered electrical resistance heating element. Another contemplated embodiment may combine the functionality described above to provide a vibrating, heat producing body 14. Such an embodiment may include independent controls 24 and 26 accessible at the outer surface 28 of the body 14 to turn on and off the heat and the vibration, as well as to control the intensity of each. As shown, the body 14 may be adapted to perform varied functionality to improve the user's ability to stimulate another during oral sex.

The shape and size of the body 14 is specifically adapted to comfortably fit into the user's cheek (FIGS. 5 and 6) without interfering with the user's tongue and without impeding the user's ability to close his or her mouth. While described primarily as an elongated egg-shaped body 14, the body 14 may take other forms. For example, as shown in FIG. 4, it is contemplated that the body 14 may include a convex cheek-facing surface 32 and a concave tongue-facing surface 34 that may more readily conform to the geometry of the cheek on one side and the penis on the other. Certainly other shapes may be employed, but the preferred versions embody smoothly contoured shapes that are most likely to be comfortable and safe for the user 12.

In the embodiments shown in FIGS. 1-4, the tail 16 of the oral sex stimulator 10 includes a bend 36, an elongated curved arm 38, and a hooked end 40. The tail 16 allows the oral sex stimulator 10 to be safely and securely “clipped” onto the user's mouth to place the body 12 within the user's mouth. This structure prevents the body 14 (or the entire oral sex stimulator 10) from being advancing too far into the user's mouth and choking the user 12. In this preferred embodiment, the tail 16 is both thin and made from a transparent material, which makes the oral sex stimulator 10 particularly unobtrusive. By providing a relatively thin tail 16, the user 12 may maintain the ability to completely close his or her mouth even with the oral sex stimulator 10 secured in place for use. By making the tail 16 from a transparent, or other non-obtrusive, material, the oral sex stimulator 10 may be less obvious and more attractive.

The curved shape of the tail 16 comfortably holds the body 14 in place within the user's mouth. And because the end of the tail 16 is hooked, the user 12 is able to slide the oral sex stimulator 10 into his or her mouth smoothly, without a risk of scratching the user's face. Further, because the hooked end 40 of the tail 16 is positioned away from the user's mouth back along the user's cheek, the hooked end 40 is less likely to interfere with any interaction between the two people.

In another embodiment, the tail 16 is configured to clip around a cheek of the user when the body 14 is placed inside a user's mouth. Further, the hooked end 40 may be configured to hook around a user's ear. By having the hooked end 40 secured around a user's ear, the oral sex stimulator 10 will be further concealed. In addition, when the hooked end 40 is secured around a user's ear, it prevents the body 14 (or the entire oral sex stimulator 10) from being advancing too far into the user's mouth and choking the user 12.

The tail 16 may be formed from any of a number of suitable materials. In one example, the tail 16 is formed from stainless steel which provides a very strong, stable, and easy to clean oral sex stimulator 10. In other embodiments, the tail 16 may be formed from any of a variety of suitable plastics. Such versions may be both easy to clean and lightweight. Polymeric versions of the tail 16 may be able to take advantage of transparency to minimize the visual impact of the oral sex stimulator 10.

As shown in FIGS. 5 and 6, the user 12 may place the body 14 of the oral sex stimulator 10 in the user's mouth and use the tail 16 of the oral sex stimulator 10 to comfortably secure it in place. As shown, when the oral sex stimulator 10 is comfortably secured in place in the user's mouth, the tail 16 minimally interferes with the user's ability to close his or her mouth and the body 14 is perfectly positioned to not interfere with the use of the tongue, but is located in a position such that it will make effective direct contact with a penis when inserted into the user's mouth.

While described herein with respect to specific illustrated embodiments, it should be noted that various changes and modifications to the presently preferred embodiments of the oral sex stimulator 10 described herein will be apparent to those skilled in the art. Such changes and modifications may be made without departing from the spirit and scope of the present invention and without diminishing its attendant advantages.

I claim:

1. A oral sex stimulator comprising:
a battery powered body including a battery compartment, a silicone cover and a one or more controls; and
a tail attached to the body, wherein the tail includes a bend adjacent to the body, an elongated arm extending away from the bend, and a hooked end at the terminal end of the tail.

2. The oral sex stimulator of claim 1 wherein the battery powered body includes an electromechanical vibration device.

3. The oral sex stimulator of claim 1 wherein the battery powered body includes an electrical resistance heating element.

4. The oral sex stimulator of claim 1 wherein the one or more controls includes a power control.

5. The oral sex stimulator of claim 1 wherein one or more controls includes an intensity control.

6. The oral sex stimulator of claim 1 wherein the body is generally egg-shaped.

7. The oral sex stimulator of claim 1 wherein the body includes a convex cheek-facing surface and a concave tongue-facing surface.

8. The oral sex stimulator of claim 1 wherein the tail is formed from a transparent polymer.

9. The oral sex stimulator of claim 1 wherein the hooked end curves in an opposite direction than the bend adjacent to the body.

10. A oral sex stimulator comprising:
a battery powered body including a battery compartment, a silicone cover and a one or more controls; and
a tail attached to the body, wherein the tail is configured to clip around a cheek of a user.

11. The oral sex stimulator of claim 10 wherein the tail further comprises a hooked end that is configured to hook around an ear of the user.

12. The oral sex stimulator of claim 10 wherein the battery powered body includes an electromechanical vibration device.

13. The oral sex stimulator of claim 10 wherein the battery powered body includes an electrical resistance heating element.

14. The oral sex stimulator of claim 10 wherein the one or more controls includes a power control.

15. The oral sex stimulator of claim 10 wherein one or more controls includes an intensity control.

16. The oral sex stimulator of claim 10 wherein the body is generally egg-shaped.

17. The oral sex stimulator of claim 10 wherein the body includes a convex cheek-facing surface and a concave tongue-facing surface.

18. The oral sex stimulator of claim 10 wherein the tail is formed from a transparent polymer.
